(19) United States
(12) Patent Application Publication
(10) Pub. No.: US 2002/0198606 A1
(43) Pub. Date: Dec. 26, 2002

(54) Data processing system and control method

(76) Inventor: Takeshi Satou, Tokyo (JP)

Correspondence Address: William C. Rowland, BURNS, DOANE, SWECKER & MATHIS, L.L.P., P.O. Box 1404, Alexandria, VA, 22313-1404, US

(21) Appl. No.: 10/175,447

(22) Filed: Jun. 20, 2002

(30) Foreign Application Priority Data
Jun. 25, 2001 (JP) 2001-191547

(51) Int. Cl. G05B 19/18

(52) U.S. Cl. 700/2; 700/4; 700/5

(57) ABSTRACT

A data processing system of this invention comprises a first processing unit for performing first data processing, a second processing unit for performing second data processing and a fetch unit for issuing an instruction code fetched from a code memory to the first processing unit if the fetched instruction code is a type 1 instruction code for the first processing unit and issuing the fetched instruction code to the second processing unit if the fetched instruction code is a type 2 instruction code for the second processing unit. In addition, the fetch unit simultaneously issues a type 1 instruction code and a type 2 instruction code to the first and the second processing units respectively if the next instruction code is a different type of instruction code to the fetched instruction code and simultaneous issuing is possible.

### BACKGROUND OF THE INVENTION

1. Technical Field

The present invention relates to a data processing system that is equipped with a plurality of processing units, such as special-purpose processing units and a general-purpose processing unit.

2. Description of the Related Art

A superpipeline method, a superscalar method, a LIW (Long Instruction Word) method, and a VLIW (Very Long Instruction Word) method are used in current microprocessors to raise the operating frequency and increase the throughput of data processing. With the superscalar method, a plurality of pipelines are provided inside a processor, a plurality of instructions are simultaneously fetched, and when the decoder finds instructions that can be executed in parallel in the decoded results, these instructions are sent to the following pipeline stages and are executed in parallel. With the VLIW method also, a plurality of pipelines are provided in a processor and parallel processing is executed, with the possibility of parallel processing being investigated during compiling and the compiler ensuring that there are no dependencies between instructions that are issued simultaneously.

With the VLIW method, the logic in the processor for issuing instructions and decoding is simplified, so that this method is suited to the development of high-performance processors that are also compact and inexpensive. When there are a plurality of processing units that perform parallel processing, instructions can be issued separately to each of the processing units, so that the processing to be performed by each processing unit can be precisely specified. This is suitable for processors used for image processing or network processing where real-time processing in clock units is required.

However, when the VLIW method is used, it is necessary to ensure that there are no dependencies between the instructions that are issued simultaneously. It is necessary to write a program so that when instructions cannot be issued in parallel to a plurality of processing units, an instruction is issued to only one of the processing units and “nop” codes are issued to the remaining processing units. This results in a fall in the program efficiency (code efficiency). The amount of code increases, which results in code memory such as code RAM being wasted and makes it more difficult to produce a compact processor.

On the other hand, advances are being made in techniques where a compact, high-performance processor is produced by dedicating the processor to a desired application. By implementing dedicated circuitry or circuit that is dedicated to various processes in the fields of image processing and network processing, for example, along with a special-purpose instruction for driving such dedicated circuitry, it is possible to produce processors that can flexibly handle the specifications of different applications and can offer superior cost performance. One kind of such processor is disclosed by the applicant of the present application in U.S. Pat. No. 6,301,650. This processor is equipped with a special-purpose processing unit (a special-purpose data processing unit, hereafter simply “VU”) and a general-purpose processing unit (basic execution unit or basic processor unit, hereafter “PU”) that can perform general-purpose processing or basic processing. In addition to the general-purpose processing service based on the PU, the specification demanded by the user can be implemented using VU, which has dedicated circuitry for processing special process of the specification, and special-purpose instructions defined by the user with a high degree of freedom.

It is preferable to use the VLIW method for the control program of the above processor that is equipped with VU and PU since the processing of VU and PU can be precisely specified. However, in a VU that is equipped with dedicated circuitry, a series of operations that is realized by dedicated circuitry is commenced by a sequencer according to a special-purpose instruction (a VU instruction), so that by issuing a single VU instruction, parallel processing can be performed by the VU and PU during the next few clocks or more by simply issuing general-purpose instructions (PU instructions) to the PU. Accordingly, when the VLIW method is used, many “nop” codes are issued, resulting in a drastic fall in code efficiency.

For the above reason, VU instructions and PU instructions are sequentially coded or arranged in a program, and a method where a fetch unit fetches a VU instruction and a PU instruction in the program in order is used. When a VU instruction is fetched, the fetch unit supplies the VU instruction or an instruction produced by decoding the VU instruction to the VU. In the same way, when a PU instruction is fetched, the fetch unit supplies the PU instruction or an instruction produced by decoding the PU instruction to the PU. With this method, the code efficiency of the program is extremely high, so that programs can be made compact. In each clock, a PU instruction or a VU instruction is fetched, with such instructions being supplied to the VU and PU in the order in which they are written in the program and processing being performed in the VU and the PU, so that the timing of the processing by the VU and the PU can be completely controlled at the program level. This means that the processing in the VU and the PU, including parallel processing, can be controlled without providing a communication system or circuit for performing cooperative control.

In the above program control method, a VU instruction and a PU instruction cannot be simultaneously issued to the VU and PU, so that when a VU instruction is issued, the timing is adjusted by issuing a nop instruction to the PU in order to supply PU instructions to the PU and VU instructions to the VU respectively. This is inferior to the VLIW method where it is possible to simultaneously issue a VU instruction and a PU instruction, so that from the viewpoint of execution speed, it is preferable to use the VLIW method.

It is a first object of the present invention to provide a data processing apparatus or system and a control method for a data processing system whose code efficiency is as high as when VU instructions and PU instructions are sequentially arranged and whose processing speed is as high as when the VLIW method is used. A second object of the present invention is to provide, at low cost, a compact data processing apparatus that has an even higher processing speed and enables programs or program products to be compactly produced.

### SUMMARY OF THE INVENTION

According to the present invention, information that shows whether simultaneous issuing of an instruction with another type of instruction is possible is included in at least one of a type 1 instruction for a first processing unit and a type 2 instruction for a second processing unit. The type 1 instruction and type 2 instruction composing a program or program product for a data processing system which includes the first processing unit for performing first data processing and the second processing unit for performing second data processing. A data processing system of this invention, in addition to the first processing unit and the second processing unit, includes a fetch unit for issuing an instruction code fetched from a code memory or a decoded data of the fetched instruction code to the first processing unit if the fetched instruction code is a type 1 instruction code for the first processing unit and issuing the fetched instruction code or the decoded data to the second processing unit if the fetched instruction code is a type 2 instruction code for the second processing unit. The fetch unit also simultaneously issues a type 1 instruction code or a decoded data of the type 1 instruction code and a type 2 instruction code or a decoded data of the type 2 instruction code to the first processing unit and the second processing unit respectively including a next instruction code that follows the fetched instruction code if the next instruction code is a different type of instruction code to the fetched instruction code and simultaneous issuing is possible.

A control method for controlling a data processing system according to the present invention includes the steps of: fetching an instruction code from a code memory; issuing, when the fetched instruction code is a type 1 instruction code for the first processing unit, the fetched instruction code or the decoded data thereof to the first processing unit; issuing, when the fetched instruction code is a type 2 instruction code for a second processing unit, the fetched instruction code or the decoded data thereof to the second processing unit; and simultaneously issuing a type 1 instruction code or the decoded data thereof and the type 2 instruction code or the decoded data thereof to the first processing unit and the second processing unit respectively including a next instruction code that follows the fetched instruction code if the next instruction code is a different type of instruction code to the fetched instruction code and simultaneous issuing is possible.

With the data processing apparatus and control method according to the present invention, type 1 instructions in the program are issued to the first processing unit, type 2 instructions in the program are issued to the second processing unit, and if the next or following instruction code is a different type of instruction to the fetched instruction code and simultaneous issuing is possible, the fetched instruction and the next instruction, namely, the type 1 and the type 2 instructions are simultaneously issued to the first processing unit and the second processing unit respectively as in the VLIW method. This means that even if type 1 instructions and type 2 instructions are arranged in the program so that instructions are fetched in order, when the next instruction code is a different type of instruction to a fetched instruction code and simultaneous issuing is possible, the type 1 and the type 2 instructions can be simultaneously issued to the first processing unit and the second processing unit. This means that there is no need to include nop instructions in a program, even when the program includes instructions for a plurality of processing units. On the other hand, when instructions for a plurality of processing units are close to each other or adjacent in the program, these instructions can be simultaneously supplied to the plurality of processing units in parallel in the same way as in the VLIW method, so that the processing speed can be increased. This means that a plurality of processing units can be controlled by a program or program product stored in a memory medium such as RAM or ROM with high code efficiency at the same processing speed as when the VLIW method is used.

One example of the first processing unit is a special-purpose processing unit equipped with dedicated circuitry that is suited to special data processing, which is to say, a VU, while one example of the second processing unit is a general-purpose processing unit that is suited to general-purpose data processing, which is to say, a PU. Accordingly, the present invention can provide a data processing apparatus and a control method for a data processing apparatus which, from the viewpoint of code efficiency, is as efficient as when the VU instructions and PU instructions are sequentially arranged and, from the viewpoint of execution speed, has as high a processing speed as when the VLIW method is used. Programs can be compactly produced, so that a compact data processing apparatus with an even higher execution speed can be provided at low cost.

In the fetch unit, in order to simultaneously refer to the next or following instruction code, it is necessary to double the bus width of the data bus and to make appropriate modifications to the code memory, resulting in significant changes to the hardware. Accordingly, it is preferable for the fetch unit to include a fetch register in which at least one instruction code that has been fetched from the code memory can be stored; a selection unit for issuing a type 1 instruction code and a type 2 instruction code to the first processing unit and the second processing unit respectively with selecting from a first instruction code that has been stored in the fetch register and a second instruction that is being fetched from the code memory; and a control unit for judging the types and simultaneous issuability of the first instruction code and the second instruction code and controlling the selection unit. With this configuration, instruction codes are temporarily stored in the fetch register, and the following instruction codes are outputted from the code memory, so that the fetched instruction code and the next instruction code can be simultaneously accessed. This enables the control method of the present invention to be used without the bus width for fetching instructions from the code memory having to be changed.

### BRIEF DESCRIPTION OF THE DRAWINGS

These and other objects, advantages and features of the invention will become apparent from the following description thereof taken in conjunction with the accompanying drawings which illustrate a specific embodiment of the invention. In the drawings:

FIG. 1 is a block diagram showing the construction of a data processing apparatus (processor) according to the present invention;

FIG. 2A shows the instruction format, while FIG. 2B shows the content of the flags;

FIG. 3 is a block diagram showing the configuration of the FU;

FIG. 4 is a flowchart showing the processing of the FU;

FIG. 5 shows the flow of the processing by a VUPU processor that is equipped with an FU according to an embodiment of the present invention; and

FIG. 6 shows the flow of the processing by a processor that is not equipped with a simultaneous issuing function.

### DESCRIPTION OF THE PREFERRED EMBODIMENT

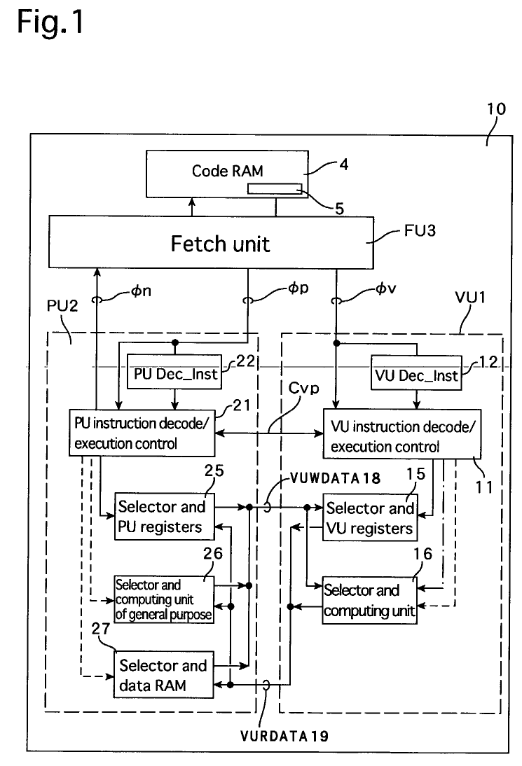

The following describes the present invention with reference to the attached drawings. FIG. 1 shows the configuration of a data processing system 10. The data processing system 10 a system LSI (Large Scale Integrated Circuit) or a processor and includes a special-purpose processing unit 1 (a special-purpose data processing unit, hereafter referred to simply as a “VU”) that is specially designed for special-purpose processing and a general-purpose processing unit 2 (a general-purpose data processing unit or basic processing unit, hereafter “PU”) with a configuration suited to general-purpose processing. The processor 10 is also equipped with a fetch unit (hereafter, “FU”) 3 that supplies decoded control signals or instructions (in this specification, the instruction code some time includes the decoded control signal or decoded instruction) to the VU 1 and the PU 2, with these three components being implemented in a single chip. The FU 3 fetches instruction codes (microcodes) from executable program code (microprogram code, object code or object program, also referred to simply “program”) 5 that is stored in a code RAM 4, which may be provided in the same chip or may be connected by a suitable bus, and outputs the fetched instruction code as decode stage instructions. The program 5 stored in the code RAM 4 includes special-purpose instructions (hereafter, “VU instructions”) that specify processing performed by the VU 1 and general-purpose instructions (hereafter, “PU instructions”) that specify processing performed by the PU 2. The FU 3 has a function for decoding these VU instructions and PU instructions and supplying the decoded results to the VU 1 and the PU 2 as signals or instruction codes,

The special-purpose processing unit VU 1 executes special-purpose instructions (VU instructions) that are user instructions. The VU 1 is equipped with a register 12 that stores the VU decode stage instruction φv, and a decode/execution control circuit 11 that decodes the VU decode stage instruction φv and controls the processing in circuitry that is suited to the data processing indicated by the VU instruction φv. As the dedicated circuitry, the VU 1 of the present embodiment is equipped with a first special-purpose circuit 15 that includes selector logic for switching the input/output data path and can access VU registers, and a second special-purpose circuit 16 that includes selector logic and is equipped with a VU computing unit, and by combining these two circuits is constructed as a circuit that is suited to special-purpose processing. The processing in the special-purpose circuits 15 and 16 that are composed of the VU computing unit and the VU registers is controlled and/or executed by hardware logic using a sequencer or hard-wired logic and the like, and is designed specifically for the special-purpose data processing. This means that while there is little flexibility, the special-purpose data processing is executed at high speed.

The general-purpose processing unit PU 2 is an execution unit for general-purpose instructions or basic instructions. In the present embodiment, the PU 2 is equipped with a register 22 for storing a PU decode stage instruction φp and a decode/execution control circuit 21 for decoding a PU instruction φp and controlling circuitry that includes a general-purpose computing unit, such as an ALU (Arithmetic Logic Unit). The circuitry that performs the general-purpose processing can be thought of as a combination of a first general-purpose circuit 25 that includes selector logic for switching the input/output data path and can access general-purpose registers (PU registers), a second general-purpose circuit 26 that includes selector logic and flag generating logic and is equipped with a general-purpose computing unit, and a third general-purpose circuit 27 that includes selector logic and can access a data RAM.

Two data buses VUWDATA 18 and VURDATA 19 for transferring data and a signal line for transferring a VU/PU control signal Cvp that performs control when these data buses are used are also provided between the VU 1 and the PU 2.

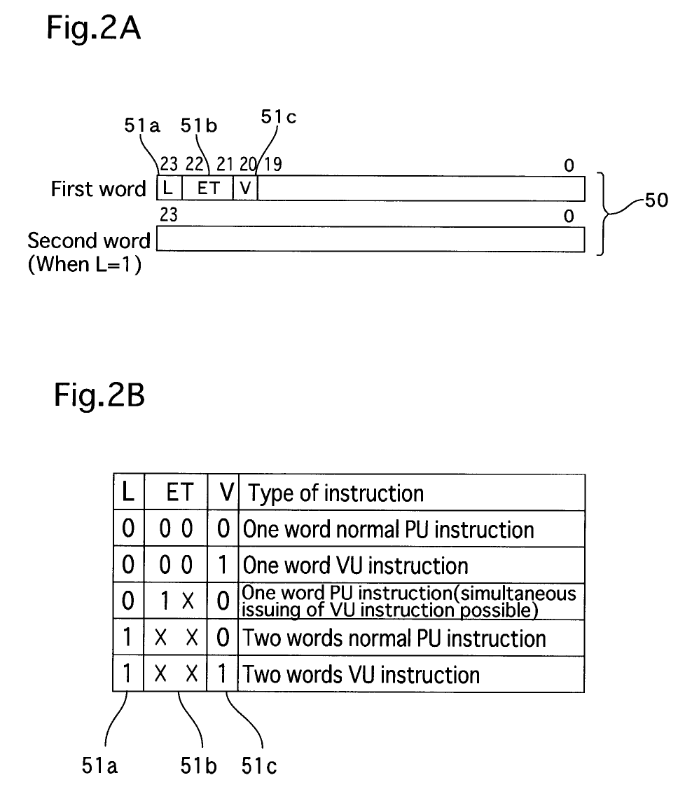

FIG. 2A shows the format of the instruction sets that compose a program 5. FIG. 2B shows the types of instruction that are indicated by the flags in the instructions. Each instruction 50 in the program 5 in the present embodiment is a variable-length instruction of up to two words, where each word is composed of 24 bits. The 23^{rd} bit L of the first word 51 is the data 51a that shows the instruction length. By decoding this data 51a, the instruction length can be determined. The 22^{nd} to 21^{st} bits of the first word form the data 51b that shows the parallel execution flag ET. The following 20^{th} bit is the data 51c, which is a flag V showing whether the instruction is a PU instruction or a VU instruction. The flag 51c is set at “0” in a PU instruction and at “1” in a VU instruction.

When the parallel execution flag ET is set at “1X”, and the instruction is a one-word PU instruction and the following or next instruction is a VU instruction that is one-word long, the parallel execution flag ET signifies that the present PU instruction and the following VU instruction can be simultaneously issued and simultaneously or parallel executed by the PU 2 and the VU 1. In other words, if the flag ET of the fetched instruction 50 is “1X”, the word length L is “0” and the flag V is “0”, and the word length L of an instruction next to the fetched instruction is “0” and the flag V is “1”, this PU instruction and this VU instruction are simultaneously or parallel issued from the FU 3 to the PU 2 and the VU 1, respectively.

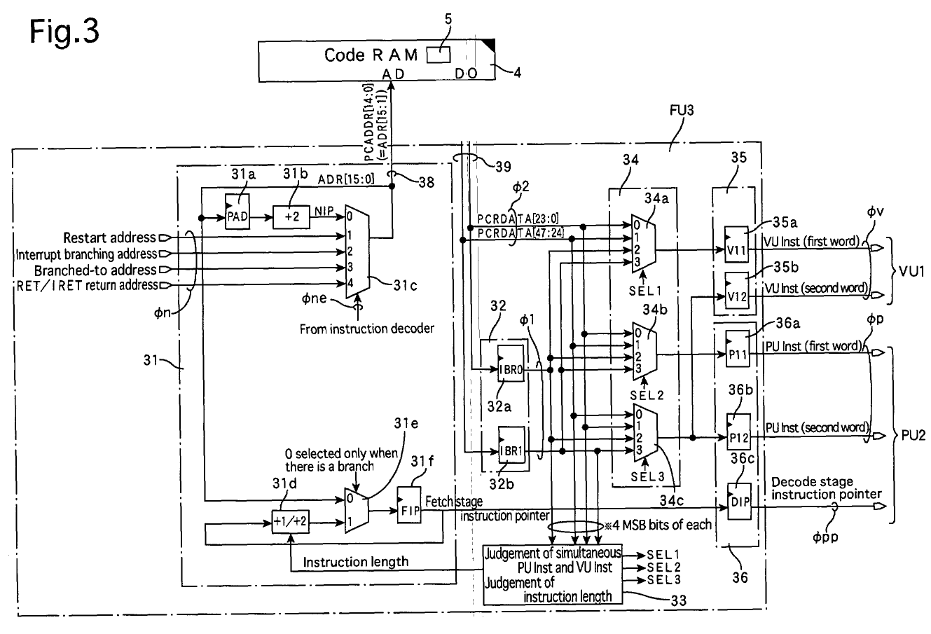

FIG. 3 shows the configuration of the FU 3. The FU 3 in the present embodiment includes a fetch address outputting circuit 31, a fetch register group 32, a VU decode stage instruction register group 35, a PU decode stage instruction register group 36, a selection circuit group 34, and a control circuit 33. The fetch address outputting circuit 31 outputs a fetch address to the code RAM 4. The fetch register group 32 can store two words of instruction codes 50 that have been fetched from the code RAM 4. The VU decode stage instruction register group 35 is used when issuing an instruction to the VU 1. The PU decode stage instruction register group 36 is used when issuing an instruction to the PU 2. The selection circuit group 34 selects one of an instruction code (a first instruction code) φ1 that has been fetched and stored in the fetch register 32 and an instruction code (a second instruction code) φ2 that is outputted from the code RAM 4 via a data bus 39 and ready for fetching, and stores the selected instruction code in the VU decode stage instruction register 35 and/or the PU decode stage instruction register 36. The control circuit 33 judges the types and simultaneous issuability of the first instruction code φ1 stored in the fetch register 32 and the second instruction code φ2 obtained from the code RAM 4, and controls the selection circuit 34.

The fetch address outputting circuit 31 is equipped with a register 31a for storing a fetch address, a computing unit 31b for computing the next fetch address by adding an address equivalent to two words to the stored fetch address, and a selector 31c for outputting the next fetch address to an address bus 38. The selector 31c receives inputs of a restart address that is included in a signal φn that is supplied to the FU 3 from a PU instruction decode/execution control circuit 21 of the PU 2, an interrupt branch address, a branched-to address of a branch instruction, and a return address. One of these addresses is selected and outputted to the address bus 38 depending on a control signal φnc included in the signal φn that in turn depends on the decoding result of the instruction code φp that has been supplied from the FU 3 to the PU 2.

The fetch address outputting circuit 31 is also equipped with a computing unit 31d that reflects the lengths of the instruction codes supplied to the VU 1 and/or PU 2 and whether instruction codes have been simultaneous issued based on the judgement of the control circuit 33, a selector 31e, and register 31f. Via the decode stage instruction pointer φpp, the address is also supplied to the PU instruction decode/execution control circuit 21 in the PU 2, and a control signal φnc that shows whether the next fetch address is required is fed back to the selector 31c.

The fetch register group 32 can store two-word data which is outputted from the code RAM 4 to the 48-bit data bus 39, and that is equipped with a two registers (IBR) 32a and 32b each of them stores one word unit. When a fetching instruction code is a two-word instruction, that one instruction code is stored in the fetch register group 32. When a fetching two words data compose two one-word instructions, two instruction codes are stored in the fetch register group 32. A width of the data bus (PCRDATA) 39 of the code RAM 4 is two words (48 bits), and the bus width can be used separately in the one word length units PCRDATA (23 to 0) and PCRDATA (47 to 24).

The selection circuit group 34 has three selectors 34a, 34b and 34c. Each of these selectors 34a to 34c receives four data. The first and second input data are the data in the registers 32a and 32b. The third and forth input data are the two word data on the data bus 39 in one word units. Each of the selectors 34a to 34c selectively outputs any one of these four inputs. The selector 34a stores the selected one word among the data in the register 35a that forms the first word of the VU decode stage instruction register group 35. The selector 34b stores the selected one word of data in the register 36a that forms the first word of the PU decode stage instruction register group 36. The selector 34c stores the selected one word of data in the register 35b that forms the second word of the VU decode stage instruction register group 35 or in the register 36b that forms the second word of the PU decode stage instruction register group 36.

The FU 3 is provided with a two-word fetch register 32, with the outputs of this register and the data bus 39 being inputted into the selection circuit 34. Therefore, By using the data bus 39 that has a bus width of two words, without extending the bus width, among two successive two-word pieces of data, which is to say, total of four words of data, a two word or one word VU instruction or PU instruction can be selected. In addition, among them, a combination of VU instruction and PU instruction having total of three words can be selected.

Information composed of the first MSB 4 bits in the data stored in each of the registers 32a and 32b, and information composed of the first MSB 4 bits of each of the two words of the data bus (PCRDATA) 39 of the code RAM 4 (which is to say, the first four bits of both the PCRDATA (23 to 0) and the PCRDATA (47 to 24)) are supplied to the control circuit 33. From these information, the control circuit 33 decodes the definition codes of the data length (L) 51a, the simultaneous executability (ET) 51b, and the type (V) 51c of each instruction code, and controls the selectors 34a, 34b and 34c in accordance with this decoding result.

In the FU 3, the fetch register 32 latches the two-word data that appears on the (two-word) data bus 39 when a fetch address is supplied to the code RAM 4, and the next fetch address is supplied to the code RAM 4 so that the next two words of data can be outputted to the data bus 39. The information in the first MSB 4 bits of each of these four words of data can be decoded by the control circuit 33. As a result, regardless of how variable-length instructions of up to two words are combined, the first word of at least one instruction code can be stored in the registers 32a or 32b with the first word of the next instruction code appearing in the register 32b or the 48-bit data path 39. Accordingly, the control circuit 33 can decode the first MSB 4 bits of at least two successive instruction codes 50.

As a result, the control circuit 33 can judge whether the simultaneous issuing conditions are satisfied, which is to say, whether there is a one-word PU instruction that is followed by a one-word VU instruction. Since the PU instruction that is simultaneously issued is one word long, the maximum amount of data that can be simultaneously issued is three words. This is to say, the combinations of instructions that can be simultaneously issued are a one-word PU instruction and a one-word VU instruction and a one-word PU instruction and a two-word VU instruction. Two fetch operations are consecutively performed using the two-word data bus 39 to provide four words of data and thereby ensure that the combinations of PU instruction and VU instruction that can be simultaneously issued can be obtained. The third selector 34c can be commonly used to set the second word of a PU instruction or a VU instruction.

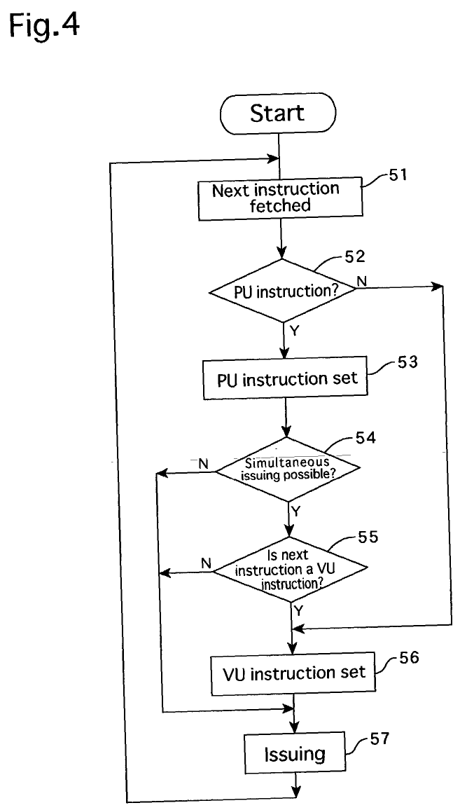

FIG. 4 is a flowchart showing the processing by the FU 3 for issuing PU instructions and VU instructions. First, in step 51, the next instruction is fetched. In step 52, the first MSB information is analyzed, and when the instruction is a PU instruction, in step 53 the PU instruction is set in the PU decode stage instruction register group 36. On the other hand, if the instruction is a VU instruction, in step 56 the VU instruction is set in the VU decode stage instruction register group 35. Next, in step 57 the VU instruction φv set in the VU decode stage instruction register group 35 or the PU instruction φp set in the PU decode stage instruction register group 36 is issued to the VU 1 or the PU 2. The VU instruction φv or PU instruction φp is stored in the decode stage instruction register 12 of the VU 1 or the decode stage instruction register 22 of the PU 2, with the VU 1 or the PU 2 executing the processing specified by this instruction.

When the instruction code fetched in step 52 is a PU instruction and in step 54 the simultaneous issuing flag (ET) 51b indicates that simultaneous issuing of instructions is possible, in step 55 it is confirmed from the data stored in the fetch register 32b and the data on the data bus 39 that the next instruction is a VU instruction. If the next instruction is a VU instruction, in step 56 the next VU instruction is set in the VU decode stage instruction register 35. In step 57 the VU instruction is simultaneously issued with the PU instruction. By doing so, a “nop” instruction does not need to be inserted as a PU instruction when the next VU instruction is issued.

This is to say, with the FU 3 of the present embodiment, the following VU instruction can be simultaneously executed without a nop code having to be inserted as a PU instruction. To do so, the FU 3 reads two words of instructions (which may extend beyond the width of the bus) and sets the first word as a PU instruction and the second word as a VU instruction in accordance with the definition codes in the MSB 4 bits, before supplying the instructions to the decode/execution control unit 21 of the PU 2 and the decode/execution control unit 11 of the VU 1. To do so, the selection circuit group 34 is provided between the code RAM 4 and the VU decode stage instruction register 35 and PU decode stage instruction register 36 that provide instruction codes (decode stage instructions or decoded data) to the decode/execution control unit 11 and the decode/execution control unit 21.

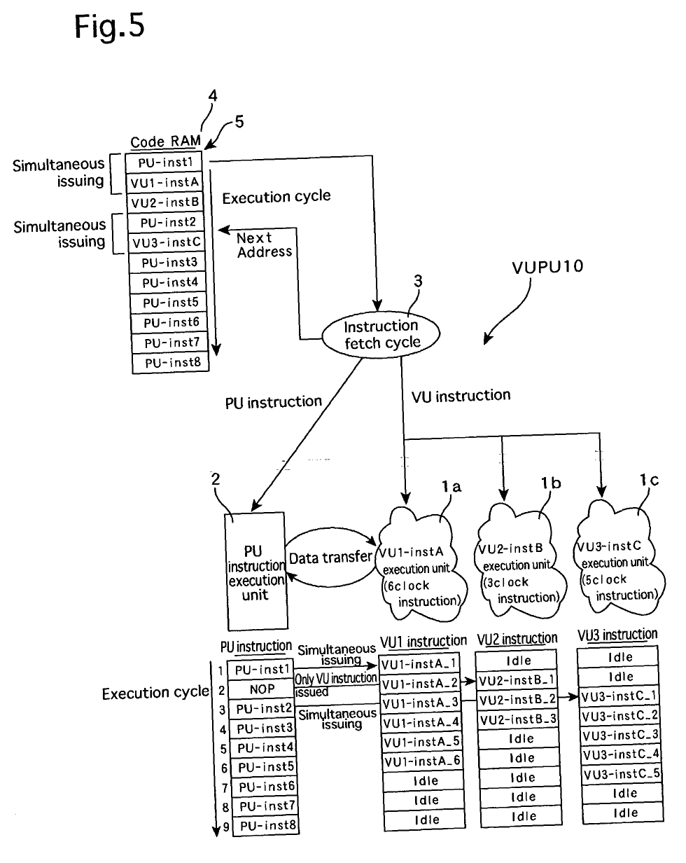

FIG. 5 shows how the program 5, in which VU instructions and PU instructions (including simultaneous issuing flags) are arranged in order, is executed in a processor (data processing apparatus) 10 according to the present invention that includes VUs 1, a PU 2 and the FU 3 described above. The processor 10 is equipped with three VUs, VU 1a, VU 1b, and VU 1c. The VU 1a commences processing that takes 6 clocks according to the VU 1 instruction, the VU 1b commences processing that takes 3 clocks according to the VU 2 instruction, and the VU 1c commences processing that takes 5 clocks according to the VU 3 instruction. First, the FU 3 fetches the first PU instruction (PU-inst1), and when this instruction PU-inst1 is a one word instruction whose simultaneous issuing flag (ET) 51b is “ON”, the next VU instruction (VU1-instA) is simultaneously issued with the PU instruction. As a result, processing is performed according to the PU-inst1 in the PU 2 and at the same time the VU 1a verifies that the instruction is a VU1-instA (the VU instruction for the VU 1a), and commences the 6-clock processing.

Next, once the FU 3 has fetched the next VU instruction (VU2-instB), this VU2-instB instruction is issued by itself, and a “nop” instruction is supplied to the PU 2. The VU 1b verifies that the instruction is a VU2-instB (the VU instruction for the VU 1b), and commences the 3-clock processing.

The FU 3 then fetches the next PU instruction (PU-inst2), and when this instruction PU-inst2 is a one word instruction whose simultaneous issuing flag (ET) 51b is “ON”, the next VU instruction (VU1-instC) is simultaneously issued with the PU instruction. As a result, processing is performed according to the PU-inst2 in the PU 2 and at the same time the VU 1c verifies that the instruction is a VU3-instC (the VU instruction for the VU 1c), and commences the 5-clock processing. In this way, with the present embodiment, the PU-inst1 and the VU1-instA instructions are simultaneously issued, as are the PU-inst2 and the VU3-instC instructions. As a result, the processing from PU-inst1 to PU-inst8, which is provided by the program 5 and includes three VU instructions, is completed in nine clocks.

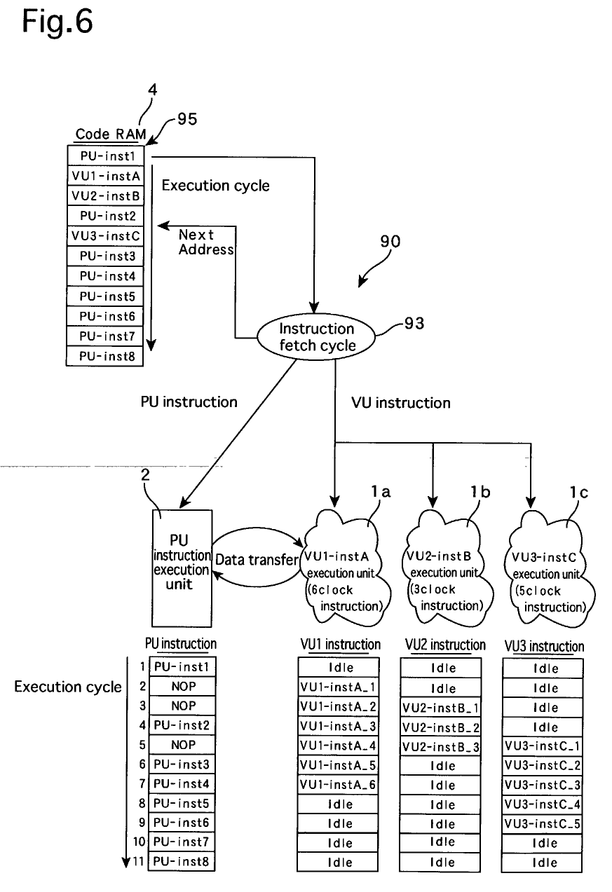

As shown in FIG. 6, a program 95 composed of instructions codes that do not include simultaneous issuing flags was produced and a VUPU processor 90 that uses a FU 93 that does not have a simultaneous issuing function was considered. In this processor 90, the FU 93 first fetches the first PU instruction (PU-inst1), this PU-inst1 instruction is supplied to the PU 2, and processing is performed by the PU 2. Next, when the VU instruction (VU1-instA) is fetched, the VU1-instA is issued by itself, and a nop code is issued to the PU 2. As a result, the VU 1a verifies that the instruction is a VU1-instA (the VU instruction for the VU 1a), and commences the 6-clock processing. After this, the FU 93 fetches the next VU instruction (VU2-instB), this VU2-instB instruction is issued by itself, and a “nop” instruction is supplied to the PU 2. The VU 1b verifies that the instruction is a VU2-instB (the VU instruction for the VU 1b), and commences the 3-clock processing.

Then, the FU 93 fetches the next PU instruction (PU-inst2) and this PU-inst2 instruction is issued by itself. After this, the next VU instruction (VU3-instC) is fetched, this VU3-instC instruction is issued by itself (a “nop” instruction is supplied to the PU 2), the VU 1c verifies that the instruction is a VU3-instC (the VU instruction for the VU 1c), and commences the 5-clock processing. In this way, in a VUPU processor 90 that does not have a simultaneous issuing function, 11 clocks are consumed to complete the processing in the program 95 that includes the PU-inst1 to PU-inst8 and three VU instructions.

With the VUPU processor 90 shows in FIG. 6 that does not have a simultaneous issuing function, parallel processing by the PU 2 and the VU 1a commences from the second cycle in which a multicycle VU instruction (VU1-instA) is issued, with no processing being performed by the PU 2 in the first cycle of VU1-instA. On the other hand, with the VUPU processor 10 of the present embodiment, a VU instruction can be issued in the first cycle, and parallel processing can be performed by the PU 2 in the first cycle of the VU instruction also. By producing a program 5 using instruction codes with simultaneous issuing flags that show whether a PU instruction can be simultaneously issued with a VU instruction and using a VUPU processor 10 that is equipped a FU 3 with a function for simultaneously issuing a PU instruction and a VU instruction, a reduction can be made in the overall number of cycles required to perform the same processing, thereby further increasing the processing speed.

It should be noted that in the present embodiment, simultaneously issuing is performed for a set where a PU instruction and a following VU instruction are each one word long, so that in the example shown in FIG. 5, PU-inst1 and VU1-instA are simultaneously issued as a pair, as are PU-inst2 and VU3-instC. On the other hand, when VU2-instB is issued, a nop code is issued to the PU 2. However, by providing VU instructions with information showing whether simultaneously issuing is possible and configuring the control circuit 33 so as to investigate whether a PU instruction can be simultaneously issued with a VU instruction that has been fetched, it becomes possible for the VU instruction VU2-instB to be simultaneously issued with the following PU instruction, thereby making it possible to further reduce the processing time.

The format of the instruction codes and circuit configuration of the FU 3 that are described above are mere examples, so that the present invention is not limited to this format and circuit configuration. While the present embodiment is described using an example in which a total length of the instructions that are simultaneously issued has a maximum of three words, it is also possible for two two-word instructions to be simultaneously issued. However, when data is fetched two words at a time, there is the possibility of the two two-word instructions spanning the data fetched in three fetch operations. In this case, it is necessary to increase the bus width of the data bus and the number of fetch registers, resulting in an increase in the scale of the hardware. The present invention is also not restricted to the simultaneous issuing of two instructions, so that should also be obvious that a configuration in which three or more instructions are simultaneously issued is possible, though it is thought that the efficiency with which hardware is utilized will fall relative to the increase in the hardware scale. In the VUPU processor 10 of the present embodiment, from the viewpoint of the frequency with instructions appear, the majority of the 24-bit instructions, which is to say, one-word instructions are PU instructions. As a result, the above configuration can sufficiently achieve the effects of the present invention, in addition to being economical.

As described above, in this invention, if it is possible to simultaneously issue VU instructions and PU instructions that are sequentially arranged in a program, these instructions can be accumulated in registers and simultaneously issued, so that it is possible to eradicate the time difference in the processing the VU and the PU in the same way as when the VLIW method is used, thereby improving the processing speed of a VUPU processor. On the other hand, in terms of the code efficiency, a program can be produced by sequentially arranging VU instructions and PU instructions, so that there is no decrease in code efficiency as happens with the VLIW method. Therefore, the execution speed of a program can be increased without increasing the hardware taken up by the program, so that a compact data processing apparatus can be provided at low cost.

The VUPU processor described above is one example of a data processing system that includes a plurality of processing units that suited to different processing. The processor includes a VU or VUs, in which the processing in a user specification that needs to be executed at high speed can be implemented by dedicated circuitry, and a PU that supports general-purpose functions such as error handling, and that can flexibly handle changes in the specification due to a program, so that the processor offers both a programmable flexibility and high-speed processing through the use of dedicated circuitry. By applying the present invention, a compact, high speed processor can be realized without sacrificing flexibility, with such a processor being one of the most suitable data processing apparatuses for applying the present invention.

As explained above, the present VUPU processor offers both a programmable flexibility and high-speed processing through the use of dedicated circuitry. The VU can be designed by the user, making the processor a highly flexible semi-customizable processor in which user instructions can be freely implemented as VU instructions. The present invention therefore makes it possible to develop and manufacture high-performance system LSIs for use as application-specific processors in an extremely short time and at low cost. The total processing time is further reduced by the present invention, so that processors that even more suited to applications, such as image processing and network processing, that need to respond in real-time.

What is claimed is:

1. A data processing system comprising:
a first processing unit for performing first data processing;
a second processing unit for performing second data processing; and
a fetch unit for issuing an instruction code fetched from a code memory or a decoded data of the instruction code to the first processing unit if the fetched instruction code is a type 1 instruction code for the first processing unit and issuing the fetched instruction code or the decoded data to the second processing unit if the fetched instruction code is a type 2 instruction code for the second processing unit, the fetch unit simultaneously issuing a type 1 instruction code or a decoded data of the type 1 instruction code and a type 2 instruction code or a decoded data of the type 2 instruction code to the first processing unit and the second processing unit respectively including a next instruction code that follows the fetched instruction code if the next instruction code is a different type of instruction code to the fetched instruction code and simultaneous issuing is possible.

2. A data processing system according to claim 1,
wherein the first processing unit is a special-purpose processing unit equipped with dedicated circuit that is suited to special data processing and the second processing unit is a general-purpose processing unit that is suited to general-purpose data processing.

3. A data processing system according to claim 1,
wherein the fetch unit includes:
a fetch register for storing at least one instruction code that has been fetched from the code memory;
selection means for issuing a type 1 instruction code or a decoded data of the type 1 instruction code and a type 2 instruction code or a decoded data of the type 2 instruction code to the first processing unit and the second processing unit respectively with selecting from a first instruction code that has been stored in the fetch register and a second instruction code that is being fetched from the code memory control means for judging the types and simultaneous issuability of the first instruction code and the second instruction code and controlling the selection means.

4. A program product for a data processing system including a first processing unit for performing first data processing and a second processing unit for performing second data processing, comprising:
at least one type 1 instruction code for the first processing unit; and
at least one type 2 instruction code for the second processing unit,
wherein the at least one type 1 instruction code and the at least one type 2 instruction code being arranged so that a type 1 instruction code and/or a type 2 instruction code are fetched in order, and
at least one of type 1 instruction codes and type 2 instruction codes including information showing whether simultaneous issuing with different type of instruction codes is possible.

5. A program product according to claim 4,
wherein the at least one type 1 instruction code is instruction code for a special-purpose processing unit equipped with dedicated circuit that is suited to special data processing and the at least one type 2 instruction code is instruction code for a general-purpose processing unit that is suited to general-purpose data processing.

6. A control method for a data processing system, comprising the steps of:
fetching an instruction code from a code memory;
issuing, when the fetched instruction code is a type 1 instruction code for a first processing unit that performs first data processing, the fetched instruction code of a decoded data of the fetched instruction code to the first processing unit;
issuing, when the fetched instruction code is a type 2 instruction code for a second processing unit that performs second data processing, the fetched instruction code or a decoded data of the fetched instruction code to the second processing unit; and
simultaneously issuing a type 1 instruction code or a decoded data of the type 1 instruction code and a type 2 instruction code or a decoded data of the type 2 instruction code to the first processing unit and the second processing unit respectively including a next instruction code that follows the fetched instruction code if the next instruction code is a different type of instruction code to the fetched instruction code and simultaneous issuing is possible.

7. A control method according to claim 6,
wherein the first processing unit is a special-purpose processing unit equipped with dedicated circuit that is suited to special data processing and the second processing unit is a general-purpose processing unit that is suited to general-purpose data processing.
